(19) United States
(12) Patent Application Publication
(10) Pub. No.: US 2006/0103870 A1
(43) Pub. Date: May 18, 2006

(54) Data output system and method for handheld wireless communication device

(75) Inventors: Cheng-Shing Lai, Taipei (TW); Chang Liu, Nanking City (CN)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 10/989,353

(22) Filed: Nov. 17, 2004

(51) Int. Cl. G06F 3/12

(52) U.S. Cl. 358/1.15; 358/1.13

(57) ABSTRACT

A data output system used in a handheld wireless communication device is disclosed, which outputs data to be printed to a printing device. The data output system comprises a link module having a link with the printing device and obtaining a data printing format, an administration module administering a plurality set of data in the handheld wireless communication device and selecting a set of data to be printed within the plurality set of data and a process module receiving the data to be printed from the administration module and converting a format of the data to be printed into the data printing format and then transmitting the converted data to the link module so as to print the data by the printing device.

### BACKGROUND OF THE INVENTION

(1) Field of the Invention

The present invention relates to a system and method for outputting data to be printed in a handheld wireless communication device, and particularly to a system and method for printing data outputting from the handheld wireless communication device through a cable link or a wireless link by a printing device.

(2) Description of the Prior Art

With the advance of the wireless technology, the current handheld wireless communication devices such as a mobile phone and a personal digital assistant (PDA) may transmit more various content from pure audio information processed by the analog handheld wireless communication device in early days to now image information processed by the prevailing third generation (3G) handheld wireless communication device. Owing to again rapid development of the wireless technology, the handheld wireless communication device has been utilized as a main medium by users in sharing various information.

Since the information content required to be transmitted has become more and more huge, the demand for capacity of the memory and display in the wireless communication device also becomes higher. However, all the now-existing handheld wireless communication devices have their limits for the volume reason and may not satisfy the requirement of the users. Therefore, a device that may print out information in a handheld wireless communication device such as a mobile phone to facilitate reading, distributing and storage must be indispensable to the users.

However, the current technology in the field may only support such kind of printing of information in a handheld wireless communication device that printing content of the telephone book or the notebook in the handheld wireless communication device by linking the handheld wireless communication device having an infrared port and a printing device configured with an infrared port. Therefore, the prior art may not address the problem encountered and may not be satisfied by the users.

### SUMMARY OF THE INVENTION

In view of the above, it is therefore an object of the present invention to provide a data output system used in a handheld wireless communication device so that various information may be outputted to a printing device and printed out.

It is another object of the present invention to provide a data output system which may be linked to the handheld wireless communication device and the printing device by a cable or a wireless connection, so that the handheld wireless communication device may output its data through a general-purpose printing device other than a printing device with an infrared port.

A data output system used in a handheld wireless communication device according to the present invention is disclosed, which outputs to-be-printed data to a printing device to be printed. The data output system comprises a link module having a link with the printing device and obtaining a data printing format, an administration module administering a plurality set of data in the handheld wireless communication device and selecting data to be printed from the plurality set of data and a process model receiving the data to be printed from the administration model and converting a format of the data to be printed into the data printing format and then transmitting the converted data to be printed to the link model so as to print the data by the printing device.

The above and other advantages and objects may be most understood by reference with the following description and the accompanying drawings below.

### BRIEF DESCRIPTION OF THE DRAWINGS

The present invention will now be specified with reference to its preferred embodiment illustrated in the drawings, in which

FIG. 1 is schematic illustration of a handheld wireless communication device according to the present invention and a printing device; and

FIG. 2 is a flow chart describing a method of a data outputting according to the present invention.

### DESCRIPTION OF THE PREFERRED EMBODIMENT

In response to the problem occurred in the prior art, the present invention provides a data output system which may output information in a handheld wireless communication device to a printing device laid externally and then the data outputted may be printed.

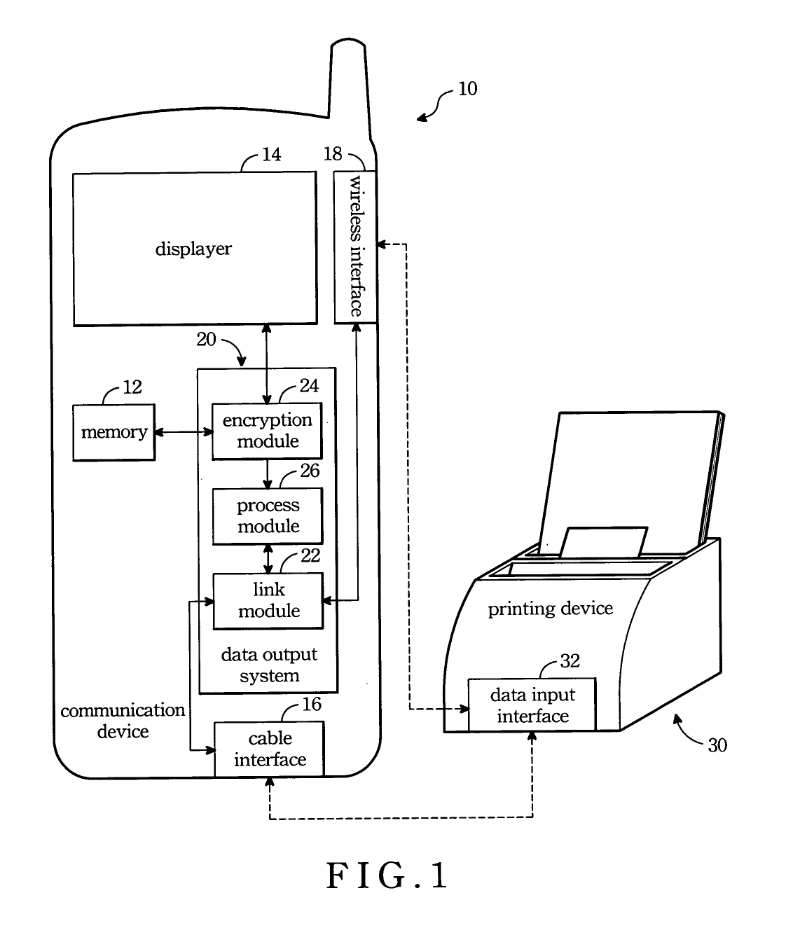

Referring to FIG. 1, the handheld wireless communication device according to the present invention and the printing device used therefore are schematically illustrated therein. The data output system 20 according to the present invention is used in the handheld wireless communication device 10 for controlling and administering data output therein as required by a user. The handheld wireless communication device 10 comprises a memory 12, a displayer 14, a cable interface 16, a wireless interface 18 and a data output system 20 and the printing device 30 comprises an input interface 32. For the present, the handheld wireless communication device is not only used for audio communication, but also serves as a schedule calendar, a note book, a communication book and the like. Also, the current handheld wireless communication may transmit information of a text form, enhanced information including simple pictures and even information including audio and video content in a multi-media form. All such information is stored in the memory in the communication device 10 and displayed by a displayer associated with the display unit in the communication device.

The data output system according to the present invention comprises a link module 22, an administration module 24 and a process module 26. In implementing the present invention, a linkage between the handheld wireless communication device and the printing device must be prepared and which is performed by the link module 22. The linkage may be achieved by several linking methods, depending upon the particular input interface 33 provided in the printing device.

In the case of a cable as the link, the handheld wireless communication device 10 is connected to the printing device 30 at its data input terminal 32 through the interface 16 of the communication device 10. The input terminal 32 has its particular interface such as a serial port, a parallel port a universal serial bus (USB) port and a network transmission port.

In case that the printing device 30 supports a wireless link, i.e., the printing device 30 has a wireless transmitting interface, e.g., an infrared input port or a blue tooth port, the handheld wireless communication device 10 may be configured with a wireless interface 18 corresponding thereto and communicates with the printing device 30 through the wireless transmitting interface of thereof. It is noted that no matter what the link type between the communication device 10 and the printing device 30 is, the cable interface 16 or the wireless interface 18 in the communication device 10 is fed with data by the link model 22. That is, the data to be printed in the communication device 10 is first transmitted to the link model 22 and then the printing device 30 through the used interface in the printing device 30 for both cable and wireless interface applications.

Since the information types recorded in the memory 12 of the communication device 10 are numerous including message information categorized into the pure text message information, enhanced message information and multi-medium message information, information of communication book, information of schedule calendar and information of note book, the administration module 24 is used to manage and categorize them. In addition, the administration module 24 also functions as a medium between the memory 12 and the displayer 14. That is, through the administration module 24 the data stored in the memory 12 may be displayed to the user by the displayer 14. In viewing through a displayer on the communication device 10, the user may select a set of data from a plurality set of data and print the selected data by transmitting them to the process module 26 to convert them into a desired information format.

Since the data printing format supported by the external printing device 30 may not be controlled by the communication device 10, the data stored in the memory and to be printed may not be outputted and directly printed in the printing device 30. In this case, the data format from the communication device 10 should be subject to a conversion of its data format. When the link module 22 is successfully connected to the printing device 30, the link module 22 confirms the data printing format supported by the printing device 30 and transmits the data printing format to the process module 26. The process module 26 receives the data to be printed from the administration module 24 and receives the printing format as described above. Further, the data format of the data to be printed is converted to the printing format according to the received data format and printing format. The to-be-printed data with the converted data format is next transmitted to the link module 22 and then to the printing device 30 through the link interface in the communication device 10. Hence, the to-be-printed data may be printed by the printing device 30 page by page.

It is to be noted that the above embodiment is described that it is after the linkage between the communication device 10 and the printing device 30 is built, will the data output system 20 perform selection and process of the to-be-printed data by the administration module 24 and the process module 26 configured therein. Alternatively, the link module 22 may establish the link to the printing device 30 after the user has selected the data to be printed and then process the data to be printed by the process module 26.

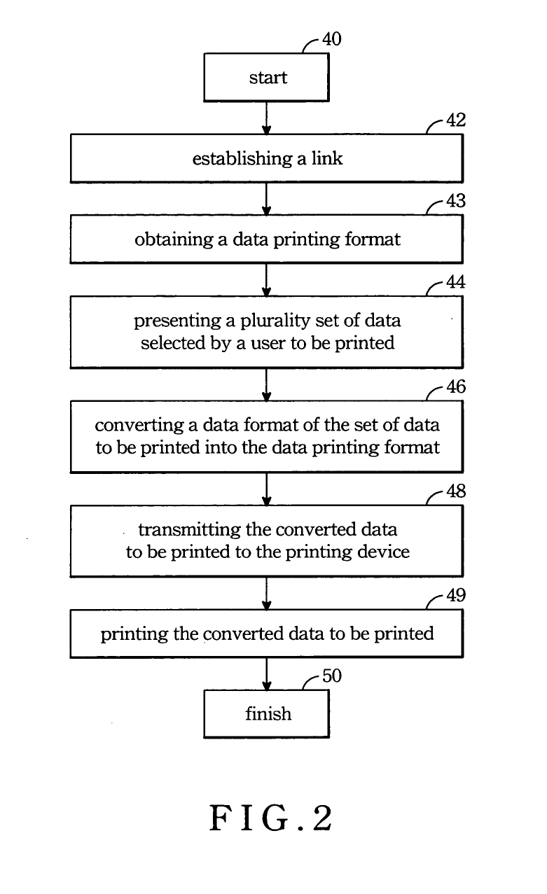

Referring to FIG. 2, a flow chart of a data output method according to the present invention is illustrated therein, which may be applied to a handheld wireless communication device. The steps of the method are recited in the following. Step 40: the method starts. Step 42: establishing a link to a printing device 30 according to a data input interface 32 used in the printing device 30. Step 43: obtaining a data printing format supported by the printing device 30 by a link module 22. Step 44: presenting a plurality set of data stored in a memory 12 through a displayer 14 by an administration module 24 to a user selecting a set of data to be printed from the plurality set of data. Step 46: converting a data format of the set of data to be printed into the data printing format. Step 48: transmitting the converted data to be printed to the printing device 30 by the link module 22. Step 49: printing the converted data to be printed. Step 50: the method ends.

Alternatively, Steps 42 and 43 may be performed after Step 44 in the method according to the present invention.

The present invention provides a printing of a to-be-printed data in the handheld wireless communication device through the printing device by establishing the link between the communication device and the printing device, determining the data printing format supported by the printing device, converting the to-be-printed data into the supported data printing format and then transmitting the converted to-be-printed data to the printing device. As a result, the handheld wireless communication device according to the present invention may be used with any printing device existing in the market and may advantageously print any data to be printed in the communication device, efficiently improving the disadvantage in the prior art that only the infrared transmitting mechanism may be used in printing data in the conventional handheld wireless communication device which causes inconvenience in use. Further, since the multi-media formed message may be read, distributed and persevered after being printed out and may not be limited by the display area and the memory capacity of the communication device, the purpose of the interest of the message in the multi-media form brought by the communication device may be well achieved.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

I claim:

1. A data output system used in a handheld wireless communication device for outputting data to be printed to a printing device to print the data, comprising:
a link module establishing a link with said printing device and obtaining a data printing format supported by said printing device, an administration module administering a plurality set of data in said handheld wireless communication device and selecting the data to be printed from the plurality set of data, wherein the plurality set of data are stored in said handheld wireless communication device in a data format supported thereby; and
a process model receiving the data to be printed from said administration model and converting the data format of the data to be printed into the data printing format and then transmitting the converted data to be printed to said link model so as to print the data to be printed by said printing device.

2. The system as recited in claim 1, wherein said link is achieved by a cable link.

3. The system as recited in claim 2, wherein said cable link is linked through a port selected from the group consisting of a serial port, a parallel port, a network connection port and a universal serial bus (USB) port.

4. The system as recited in claim 1, wherein said link is achieved by a wireless link.

5. The system as recited in claim 4, wherein said wireless link is selected from the group consisting of an infrared link and a bluetooth link.

6. The system as recited in claim 1, wherein the plurality set of data comprises message data, communication book data, schedule calendar data and notebook data.

7. The system as recited in claim 6, wherein the message data is pure text data.

8. The system as recited in claim 6, wherein said message data comprises an enhanced message data including a simple picture.

9. The system as recited in claim 6, said message data comprises a multi-medium message including a complex picture.

10. The system as recited in claim 1, wherein said handheld wireless communication device further comprises a displayer for displaying the plurality set of data to a user to select a set of data to be printed.

11. The system as recited in claim 1, wherein said handheld wireless communication device is a mobile phone.

12. The system as recited in claim 1, wherein said handheld wireless communication device is a personal digital assistant (PDA).

13. A method for outputting data stored in a handheld wireless communication device to a printing device to print the data, comprising the steps of:
establishing a link to said printing device and obtaining a data printing format supported by the printing device;
selecting the data to be printed from a plurality set of data in said handheld wireless communication device, wherein said plurality set of data are stored in said handheld wireless communication device in a data format supported thereby; and
converting the data format of the data to be printed into a data printing format supported by said print device to print the data to be printed.

14. The method as recited in claim 13, wherein said link is achieved by a cable link.

15. The method as recited in claim 14, wherein said cable link is linked through a port selected from the group consisting of a serial port, a parallel port, a network connection port and a universal serial bus (USB) port.

16. The method as recited in claim 13, wherein said link is achieved by a wireless link.

17. The method as recited in claim 16, wherein said wireless link is selected from the group consisting of an infrared link and a bluetooth link.

18. The method as recited in claim 13, wherein the plurality set of data comprises message data, communication book data, schedule calendar data and notebook data.

19. The method as recited in claim 18, wherein the message data is pure text data.

20. The method as recited in claim 18, wherein said message data comprises an enhanced message data including a simple picture.

21. The method as recited in claim 13, said message data comprises a multi-medium message including a complex picture.

22. The method as recited in claim 13, wherein said handheld wireless communication device further comprises a displayer for displaying the plurality set of data to a user to select a set of data to be printed.

23. The method as recited in claim 13, wherein said handheld wireless communication device is a mobile phone.

24. The system as recited in claim 13, wherein said handheld wireless communication device is a personal digital assistant (PDA).
